(19) United States
(12) Patent Application Publication
(10) Pub. No.: US 2026/0261135 A1
(43) Pub. Date: Sep. 3, 2026

(54) APPARATUS AND METHOD FOR PROTECTING AN IMAGE FORMING APPARATUS

(71) Applicant: Hewlett-Packard Development Company, L.P., Spring, TX (US)

(72) Inventors: Jinyun PARK, Seongnam Si (KR); Jonghwa CHO, Seongnam Si (KR); Kwanghoon CHEON, Seongnam Si (KR)

(21) Appl. No.: 18/994,745

(22) PCT Filed: Dec. 16, 2022
(86) PCT No.: PCT/US2022/053165

§ 371 Date: Jan. 15, 2025

(30) Foreign Application Priority Data
Jul. 18, 2022 (KR) 10-2022-0088459

(51) Int. Cl. H02J 7/62; G03G 15/00; G03G 15/02; G03G 15/06; H02J 7/80

(52) U.S. Cl. CPC H02J 7/62; G03G 15/0266; G03G 15/065; G03G 15/5004; G03G 15/55; G03G 15/80; H02J 7/80

(57) ABSTRACT

A high-voltage power supply apparatus supplies power in an image forming apparatus. The high-voltage power supply apparatus includes a charging circuit to output a charging high voltage to a charging device of the image forming apparatus, a developing circuit to output a developing high voltage to a developing device of the image forming apparatus, and a protecting circuit to control output of the developing circuit to be stopped when an error occurs in the charging circuit, and to control output of the charging circuit to be stopped when an error occurs in the developing circuit.

### BACKGROUND

An image forming apparatus refers to an apparatus that forms an electrostatic latent image on a surface of a photoconductor by irradiating light modulated corresponding to image information to the photoconductor, develops the electrostatic latent image into a visible toner image by supplying a toner to the electrostatic latent image, and prints an image on a recording medium by transferring and fusing the toner image onto the recording medium. The image forming apparatus has to supply a high voltage to a charging device or a developing device in the image forming apparatus to form an image in which the high voltage is generated by a high-voltage power supply device in the image forming apparatus.

In the image forming apparatus, each of a charging circuit for controlling a charging roller or a developing circuit for controlling a developing device may include over-current protection (OCP) circuits to protect a channel thereof. That is, each of the OCP circuit included in the developing circuit and the OCP circuit included in the charging circuit may protect its corresponding high-voltage channel when an error occurs in a corresponding high-voltage channel circuit. Thus, when an error occurs in any one of the developing circuit and the charging circuit, the circuit having the error occurring therein may be protected, but depending on a circumstance, a related unit and a consumable in the image forming apparatus may be damaged. In line with this, development of a technique for protecting the image forming apparatus overall is required.

The above-described technology is technical information owned for derivation of the disclosure or acquired during derivation of the disclosure, by the inventor, and does not necessarily indicate known technology published to the general public prior to filing of the present application.

### BRIEF DESCRIPTION OF THE DRAWINGS

The disclosure may be easily understood by a combination of the following detailed description and the accompanying drawings, and reference numerals may refer to structural elements.

FIG. 1 shows an image forming apparatus according to various examples of the disclosure;

FIG. 2 is a block diagram of a function of an image forming apparatus according to various examples of the disclosure;

FIG. 3 is an example of a block diagram of a high-voltage power supply apparatus according to various examples of the disclosure;

FIG. 4 is another example of a block diagram of a high-voltage power supply apparatus according to various examples of the disclosure;

FIG. 5 is a block diagram of a high-voltage power supply apparatus according to various examples of the disclosure;

FIG. 6 is a circuit diagram of a high-voltage power supply apparatus according to various examples of the disclosure;

FIG. 7 is a graph of an operation result of a high-voltage power supply apparatus according to various examples of the disclosure; and

FIG. 8 is a flowchart of an operating method of a high-voltage power supply apparatus according to various examples of the disclosure,

### DETAILED DESCRIPTION

Terms used herein are used for only describing a specific example and may not have an intention to limit the scope of other examples. It is to be understood that the singular forms include plural references unless the context clearly dictates otherwise. All terms including technical or scientific terms used herein have the same meaning as commonly understood by those of ordinary skill in the art described herein. It will be further understood that among terms used herein, terms defined in commonly used dictionaries may be interpreted as a meaning that is identical to or similar with their meanings in the context of the relevant art and will not be interpreted in an idealized or overly formal sense unless expressly so defined herein. In some cases, the terms defined herein may not be interpreted to exclude examples of the disclosure.

In various examples of the disclosure described below, a hardware approach will be described as an example. However, various examples of the disclosure include technology using both hardware and software, and thus do not exclude a software-based approach.

Hereinbelow, the disclosure relates to an apparatus and method for protecting an image forming apparatus. More specifically, the disclosure describes a technique for protecting a circuit including a charging circuit and a developing circuit and related units by controlling an operation of a high-voltage power supply apparatus in an image forming apparatus.

Hereinafter, examples of the disclosure will be described in detail with reference to the attached drawings to allow those of ordinary skill in the art to easily carry out the examples of the disclosure. However, the technical spirit of the disclosure may not be limited to the examples described herein because it may be transformed into various forms and implemented. In the description of the examples disclosed herein, the detailed description of the related known technology will be omitted when it is determined to obscure the subject matter of the technical spirit of the disclosure. Identical or similar components will be given identical reference numerals and will not be repeatedly described.

Throughout the specification, when a component is “connected” to another component, it may include not only a case where they are “directly connected”, but also a case where they are “indirectly connected” with another component therebetween. When an element is referred to as “includes” another component, it may mean that the component may further include still another component rather than excluding the still another component unless stated otherwise.

Some examples may be described with functional block configurations and various processing operations. Some or all of the functional blocks may be implemented with various numbers of hardware and/or software configurations. For example, the functional blocks of the disclosure may be implemented by one or more microprocessors or circuit configurations for certain functions. The functional blocks of the disclosure may be implemented with various programming or scripting languages. The functional blocks of the disclosure may be implemented as an algorithm executed on one or more processors. A function performed by a functional block of the disclosure may be performed by a plurality of functional blocks, or functions performed by a plurality of functional blocks may be performed by one functional block in the disclosure. Moreover, the disclosure may employ related art for electronic environment setting, signal processing, and/or data processing, etc.

In the disclosure, to determine whether a certain condition is satisfied or fulfilled, an expression of ‘exceed’ or ‘less than’ has been used, but this is merely a description for expressing an example without excluding an expression of ‘equal to or greater than’ or ‘less than or equal to’. A condition described as ‘equal to or greater than’ may be replaced with ‘exceed’, a condition described as ‘less than or equal to’ may be replaced with ‘less than’, and a condition described as ‘equal to or greater than and less than’ may be replaced with ‘exceed and equal to or less than’.

Hereinafter, examples of the disclosure will be described in detail with reference to the attached drawings to allow those of ordinary skill in the art to easily carry out the examples of the disclosure. However, the disclosure may be implemented in various different forms, and are not limited to the examples of the disclosure described herein.

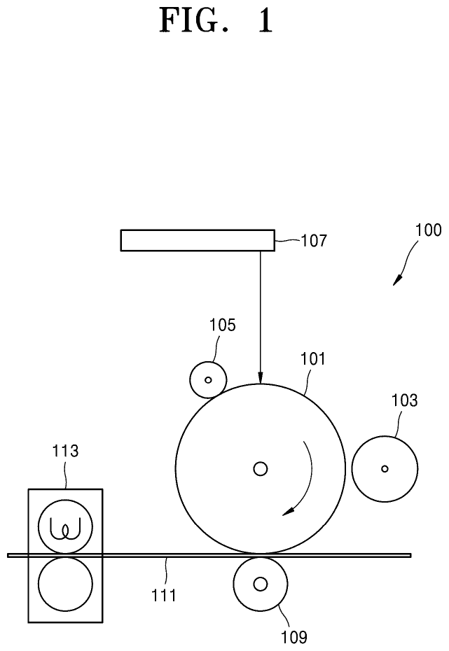

FIG. 1 shows an image forming apparatus 100 according to various examples of the disclosure. The term used herein such as ‘ . . . unit’, ‘ . . . module’, etc., indicates a unit for processing at least one function or operation, and may be implemented in hardware, software, or in a combination of hardware and software.

The image forming apparatus 100 may indicate any type of devices capable of performing an image forming job, such as a printer, a scanner, a fax machine, a multi-function printer (MFP), a display device, etc. Moreover, print data may indicate data converted into a format printable by a printer, and a scan file may indicate a file generated by scanning an image by a scanner. That is, the image forming apparatus 100 may indicate an image forming apparatus using a two-component developing agent including a toner and a magnetic carrier.

The photoconductive drum 101, which is an example of an image carrier on which an electrostatic latent image is formed, may indicate a device wherein a photoconductive layer having photoconductivity is formed on an outer circumference of a cylindrical metal pipe. According to an example of the disclosure, instead of the photoconductive drum 101, a photoconductive belt may be used wherein a photoconductive layer is formed on an outer surface of a circularly driven belt.

A developing roller 103 may indicate a developing member that supplies a toner to a surface of the photoconductive drum 101 in the developing device. The developing roller 103 may be arranged apart from the photoconductive drum 101 by a developing gap. According to an example of the disclosure, the developing roller 103 may include a rotatable sleeve and a magnet installed inside the sleeve. Herein, on regions where the sleeve and the photoconductive drum 101 face each other, moving directions of surfaces of the sleeve and the photoconductive drum 101 may be the same as each other.

A charging roller 105 may charge the surface of the photoconductive drum 101 with a uniform charging potential. To the charging roller 105, a charging bias voltage may be applied. According to an example of the disclosure, a corona charger using corona discharging may be used in place of the charging roller 105.

An exposure 107 may indicate an object that forms an electrostatic latent image by irradiating light corresponding to image information to the surface of the charged photoconductive drum 101. According to another example of the disclosure, as the exposure 107, a laser canning unit may be used which deflects light irradiated from a laser diode in a main scanning direction by using a polygon mirror to scan the photoconductive drum 101 with the light.

A transfer roller 109 may transfer a toner image formed on the photoconductive drum 101 to a sheet. The transfer roller 109 may face the photoconductive drum 101 to form a transfer nip, and a transfer bias voltage may be applied to the transfer roller 109. The toner image developed on the surface of the photoconductive drum 101 may be transferred to a recording medium 111 by a transfer electric field formed by the transfer bias voltage between the photoconductive drum 101 and the transfer roller 109. According to another example of the disclosure, a corona transfer unit using corona discharging may be used in place of the transfer roller 109.

A fuser 113 may fuse the toner image onto the recording medium 111. The toner image transferred to the recording medium 111 may be attached to the recording medium 111 by an electrostatic force, and the fuser 113 may fuse the toner image onto the recording medium 111 by applying heat and pressure to the recording medium 111.

More specifically, upon application of the charging bias voltage to the charging roller 105, the surface of the photoconductive drum 101 may be charged with a uniform electric potential. The exposure 107 may form an electrostatic latent image by irradiating light corresponding to image information to the surface of the photoconductive drum 101. When a developing electric field is formed between the developing roller 103 and the photoconductive drum 101 by application of a developing bias voltage to the developing roller 103, the toner may be moved from a developing agent layer formed on the surface of the developing roller 103 to the surface of the photoconductive drum 101, developing an electrostatic latent image. Thus, the toner image may be formed on the surface of the photoconductive drum 101. By a transfer electric field formed by a transfer bias voltage, the toner image may be moved and attached from the surface of the photoconductive drum 101 to the recording medium 111. As the recording medium 111 passes through the fuser 113, the toner image may be fused onto the recording medium 111 by heat and pressure, such that image printing may be completed.

The image forming apparatus 100 may perform the above-described image forming job by using a high voltage. That is, a high-voltage power supply apparatus may be included inside the image forming apparatus 100, and may generate a charging high voltage by using a charging circuit and supply the same to a charging roller or generate a developing high voltage by using a developing circuit and supply the same to a developing roller.

More specifically, the charging circuit may receive a pulse width modulation (PWM) signal and supply the charging high voltage to the charging roller through an output terminal. Herein, a charging over-current protection (OCP) circuit may be included in the charging circuit such that a current flowing through the output terminal is greater than or equal to a preset threshold value, the charging OCP circuit stops output of the charging circuit to prevent damage of the charging circuit. In the same manner, the developing circuit may receive the PWM signal and supply the developing high voltage to the developing roller through the output terminal, and a developing OCP circuit may stop output of the developing circuit when a current flowing through the output terminal is greater than or equal to a threshold value. That is, when the charging OCP circuit is included in the charging circuit and the developing OCP circuit is included in the developing circuit, each of the charging OCP circuit and the developing OCP circuit may protect a channel having an error occurring therein depending on over-current.

The image forming apparatus 100 operates as one device, such that when an error occurs in any one of the developing circuit and the charging circuit, the circuit having the error occurring therein may be protected, but other components may be damaged depending on a circumstance. According to an example, when a charging channel is normal and an over-current flows through a developing channel, carrier leakage may occur in the developing device, damaging the developing device and the photoconductive drum. According to another example, when an over-current flows through the charging channel and the developing channel is normal, a large amount of toner is developed with the photoconductive drum, and additional problems such as excessive use of the toner and contamination of the fuser, the transfer roller, etc., may occur.

To prevent damage of the image forming apparatus 100, precise output control of the high-voltage power supply apparatus that supplies a high voltage through the charging circuit or the developing circuit is required. Hereinbelow, a configuration and an operation of the high-voltage power supply apparatus included in the image forming apparatus 100 will be described in detail.

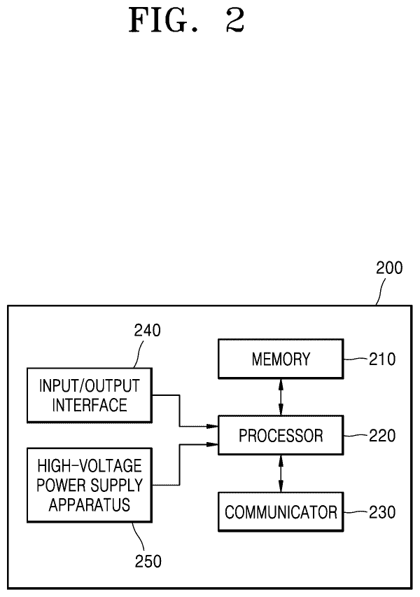

FIG. 2 is a block diagram 200 of a function of the image forming apparatus 100 according to various examples of the disclosure. The image forming apparatus 100 may include a memory 210, a processor 220, a communicator 230, an input/output interface 240, and a high-voltage power supply apparatus 250. However, all the illustrated components are not essential components. The image forming apparatus 100 may be implemented by more or less components than the illustrated components.

The memory 210 may temporarily or permanently store data such as a basic program, an application program, and configuration information for an operation of the image forming apparatus 100, and so forth. The memory 210 may provide the stored data at the request of the processor 220. According to an example of the disclosure, the memory 210 may store data indicating a magnitude of the high voltage supplied by the high-voltage power supply apparatus 250 to the charging device or the developing device.

The processor 220 may perform a function of controlling an overall operation of the image forming apparatus 100. The processor 220 may be connected to the memory 210, the communicator 230, the input/output interface 240, and the high-voltage power supply apparatus 250 to control the respective components. According to an example of the disclosure, the processor 220 may instruct the high-voltage power supply apparatus 250 to output the high voltage and to stop outputting the high voltage.

The communicator 230 may provide a function for communication between the image forming apparatus 100 and at least one another node through a communication network. When the processor 220 of the image forming apparatus 100 generates a request signal according to a program code stored in a recording device such as the memory 210, the request signal may be transmitted to the at least one other node through the communication network under control of the communicator 230.

The input/output interface 240 may be an interface with an input/output device (not shown). The input device may be provided in the form of a device such as a keyboard, a mouse, etc., and the output device may be provided in the form of a display unit for displaying an image, etc.

The high-voltage power supply apparatus 250 may perform a function of supplying a high voltage used in the image forming apparatus 100 to perform the image forming job. More specifically, the high-voltage power supply apparatus 250 may supply a high voltage to the charging device or the developing device in the image forming apparatus 100.

The high-voltage power supply apparatus 250 may include a charging circuit that supplies the charging high voltage to the charging device, a developing circuit that supplies the developing high voltage to the developing device, and a protection circuit that stops the output of the charging circuit and the developing circuit. That is, the high-voltage power supply apparatus 250 may generate the charging high voltage based on a charging input signal and output the generated charging high voltage to the charging device. In addition, the high-voltage power supply apparatus 250 may generate the developing high voltage based on a developing input signal and output the generated developing high voltage to the developing device. Herein, the high-voltage power supply apparatus 250 may determine whether the charging high voltage and the developing high voltage are output normally, and may stop both the output of the charging circuit and the output of the developing circuit when an error occurs in at least one of the charging circuit and the developing circuit.

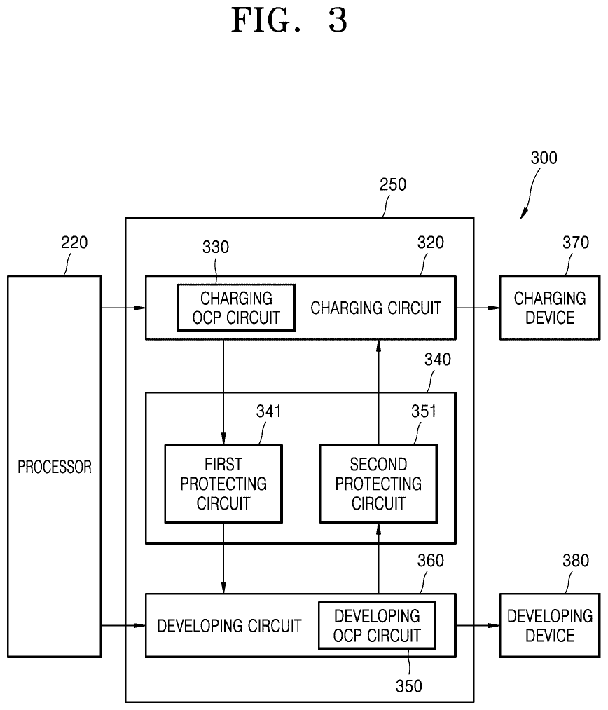

FIG. 3 is an example 300 of a block diagram of the high-voltage power supply apparatus 250 according to various examples of the disclosure.

Referring to FIG. 3, the high-voltage power supply apparatus 250 may include a charging circuit 320, a protecting circuit 340, and a developing circuit 360. More specifically, the high-voltage power supply apparatus 250 may be configured with a high-voltage board in which the charging circuit 320, the protecting circuit 340, and the developing circuit 360 may be configured. An output terminal of the charging circuit 320 may be connected to a charging device 370 to supply a charging high voltage to a charging roller. Moreover, an output terminal of the developing circuit 360 may be connected to a developing device 380 to supply a developing high voltage to a developing roller.

The high-voltage power supply apparatus 250 may receive a signal for outputting a high voltage from the processor 220. The processor 220 may transmit an input signal to the high-voltage power supply apparatus 250 through PWM control to supply the high voltage to the charging device 370 or the developing device 380. The high-voltage power supply apparatus 250 may generate a high-voltage signal based on the input signal and output the generated high-voltage signal to at least one of the charging device 370 and the developing device 380. Herein, the high-voltage power supply apparatus 250 may include the protecting circuit 340 that restricts the output of at least one of the charging circuit 320 and the developing circuit 360 to protect the image forming apparatus 100.

The charging circuit 320 may receive the charging input signal from the processor 220 and output the charging high voltage to the charging device 370. The charging circuit 320 may receive the charging input signal in the form of an alternating current (AC) generated through PWM control from the processor 220, process the received charging input signal, and generate the charging high voltage in the form of a direct current (DC). Thereafter, the charging circuit 320 may output the generated charging high voltage to the charging device 370. Herein, the charging circuit 320 may include a charging OCP circuit 330 that restricts high-voltage output of the charging circuit 320 according to whether an error occurs in the charging circuit 320.

The developing circuit 360 may receive a developing input signal from the processor 220 and output the developing high voltage to the developing device 380. The developing circuit 360 may receive the developing input signal in the form of an AC generated through PWM control from the processor 220, process the received developing input signal, and generate the developing high voltage in the form of a DC. The developing circuit 360 may output the generated developing high voltage to the developing device 380. The developing circuit 360 may include a developing OCP circuit 350 that restricts high-voltage output of the developing circuit 360 according to whether an error occurs in the developing circuit 360.

The protecting circuit 340 may perform a function of stopping the output of the charging circuit 320 and the output of the developing circuit 360 when an error occurs in at least one of the charging circuit 320 and the developing circuit 360. When the charging circuit 320 outputs an over-current, the protecting circuit 340 may stop the output of the developing circuit 360. On the other hand, when the developing circuit 360 outputs an over-current, the protecting circuit 340 may generate a stop signal for stopping the output of the charging circuit 320. To this end, the protecting circuit 340 may include a first protecting circuit 341 that stops the output of the developing circuit 360 and a second protecting circuit 351 that stops the output of the charging circuit 320.

Referring to FIG. 3, when an error occurs in the charging circuit 320, the charging OCP circuit 330 may stop the output of the charging circuit 320 and the first protecting circuit 341 may stop the output of the developing circuit 360. That is, when the charging circuit 320 outputs an over-current, the charging OCP circuit 330 included in the charging circuit 320 may stop the output of the charging circuit 320 and the first protecting circuit 341 included in the protecting circuit 340 may stop the output of the developing circuit 360, thereby stopping both the output of the charging circuit 320 and the output of the developing circuit 360.

On the other hand, when an error occurs in the developing circuit 360, the developing OCP circuit 350 may stop the output of the developing circuit 360 and the second protecting circuit 351 may generate a signal for stopping the output of the charging circuit 320. That is, when the developing circuit 360 outputs an over-current, the developing OCP circuit 350 included in the developing circuit 360 may stop the output of the developing circuit 360 and the second protecting circuit 351 included in the protecting circuit 340 may generate a stop signal for operating the charging OCP circuit 330 of the charging circuit 320, thereby stopping both the output of the charging circuit 320 and the output of the developing circuit 360.

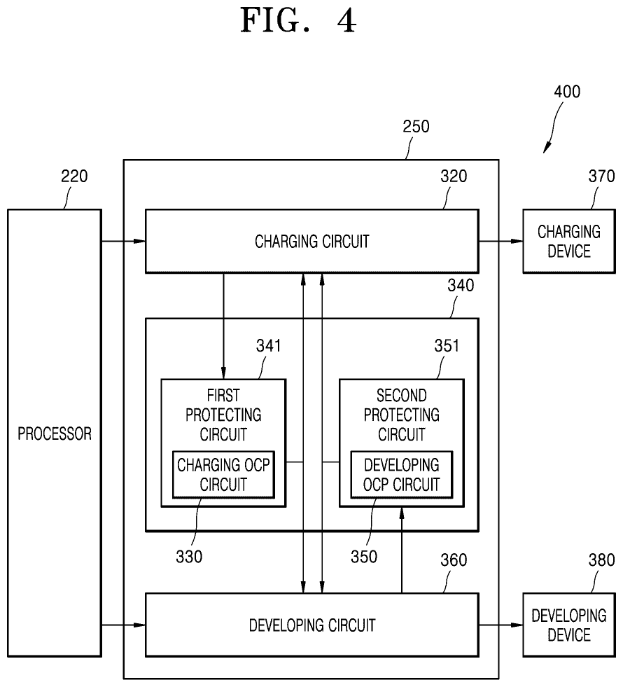

FIG. 4 is another example 400 of a block diagram of the high-voltage power supply apparatus 250 according to various examples of the disclosure.

The charging circuit 320, the protecting circuit 340, and the developing circuit 360 may be configured in the high-voltage board of the high-voltage power supply apparatus 250, and the output terminal of the charging circuit 320 may be connected to the charging device 370 and the output terminal of the developing circuit 360 may be connected to the developing device 380. The high-voltage power supply apparatus 250 may receive an input signal from the processor 220 through PWM control and output a high-voltage signal to at least one of the charging device 370 and the developing device 380.

Referring to FIG. 4, the high-voltage power supply apparatus 250 may include the protecting circuit 340 that restricts the output of the charging circuit 320 and the developing circuit 360 to protect the image forming apparatus 100. Herein, the first protecting circuit 341 may perform a function of stopping both the output of the charging circuit 320 and the output of the developing circuit 360 according to a signal received from the charging circuit 320. Likewise, the second protecting circuit 351 may perform a function of stopping both the output of the charging circuit 320 and the output of the developing circuit 360 according to a signal received from the developing circuit 360.

The charging circuit 320 may receive the charging input signal in the form of an AC generated through PWM control from the processor 220, and output the charging high voltage in the form of a DC to the charging device 370. The developing circuit 360 may receive the developing input signal in the form of an AC generated through PWM control from the processor 220, and output the developing high voltage in the form of a DC to the developing device 380. Herein, unlike shown in FIG. 3, the charging circuit 320 may not include the charging OCP circuit 330 that restricts the high-voltage output of the charging circuit 320, and the developing circuit 360 may not include the developing OCP circuit 350 that restricts the high-voltage output of the developing circuit 360. In response, the protecting circuit 340 may include the charging OCP circuit 330 and the developing OCP circuit 350 therein.

The protecting circuit 340 may stop both the output of the charging circuit 320 and the output of the developing circuit 360 when an error occurs in at least one of the charging circuit 320 and the developing circuit 360. Referring to FIG. 4, when an error occurs in the charging circuit 320, the first protecting circuit 341 may receive a sensing result indicating the over-current output of the charging circuit 320 from the charging circuit 320 and stop both the output of the charging circuit 320 and the output of the developing circuit 360 according to the sensing result. That is, when the charging circuit 320 outputs an over-current, the first protecting circuit 341 may stop the output of the charging circuit 320 and stop the output of the developing circuit 360 by using the charging OCP circuit 330 included in the first protecting circuit 341 from the charging circuit 320. In the same manner, the second protecting circuit 351 may receive a sensing result indicating the over-current output of the developing circuit 360 from the developing circuit 360 and stop both the output of the charging circuit 320 and the output of the developing circuit 360 according to the sensing result. That is, when the developing circuit 360 outputs an over-current, the second protecting circuit 351 may stop the output of the developing circuit 360 by using the developing OCP circuit 350 included in the second protecting circuit 351 and generate a signal for stopping the output of the charging circuit 320, thereby stopping both the output of the charging circuit 320 and the output of the developing circuit 360.

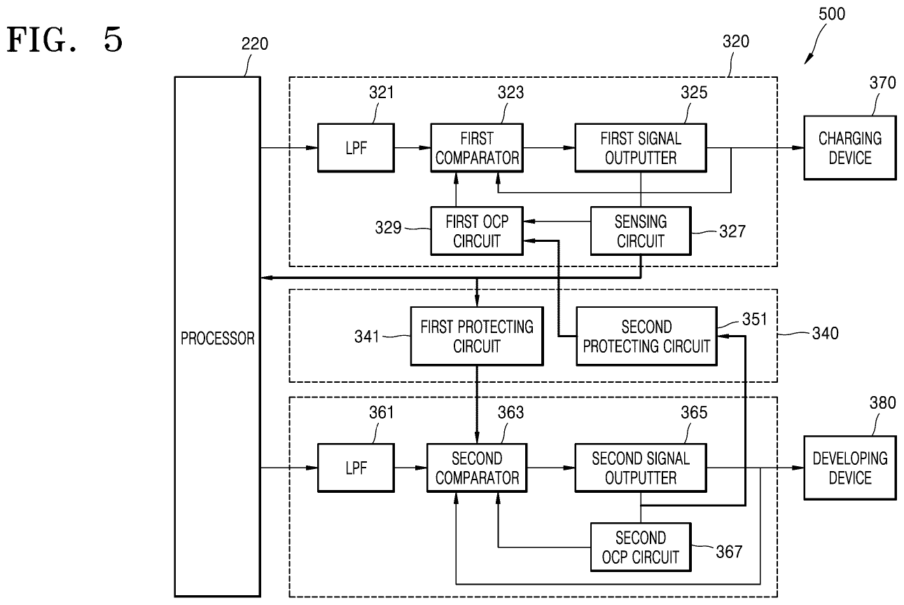

FIG. 5 is a block diagram 500 of the high-voltage power supply apparatus 250 according to various examples of the disclosure.

The high-voltage power supply apparatus 250 may output the charging high voltage to the charging device 370 by using the charging circuit 320 and output the developing high voltage to the developing device 380 by using the developing circuit 360. Herein, the high-voltage power supply apparatus 250 may further include the protecting circuit 340 for overall protection of the image forming apparatus 100.

The charging circuit 320 may include an inverter that shifts a phase of a charging input voltage applied through PWM control, a low pass filter (LPF) 321 applied to a charging input signal passing through the inverter, a first comparator 323 that controls the output of a first base voltage that is a basis for generation of a charging high voltage, a first signal outputter 325 that receives an output signal of the first comparator 323 and outputs the charging high voltage in the form of an AC, a sensing circuit 327 that senses whether the charging circuit 320 outputs an over-current from an output current of the first signal outputter 325, and a first OCP circuit 329 that stops the output of the charging circuit based on a sensing result of the sensing circuit 327.

According to an example of the disclosure, the charging circuit 320 may receive a first AC voltage based on PWM control from the processor 220. The first AC voltage may be phase-shifted through the inverter, and may be converted into a first DC voltage through the LPF 321 and transmitted to the first comparator 323. At this time, the charging high-voltage signal output from the charging circuit 320 may be fed back to the first comparator 323. The first comparator 323 may compare the first DC voltage and a feedback voltage with a first reference voltage to output the first base voltage for generation of the charging high voltage. The first signal outputter 325 may receive the first base voltage to generate the charging high voltage and output the generated charging high voltage to the charging device 370.

The developing circuit 360 may include an inverter that shifts a phase of a developing input voltage applied from the processor 220 through PWM control, an LPF 361 applied to a charging input signal passing through the inverter, a second comparator 363 that controls the output of a second base voltage that is a base for generation of a developing high voltage, a second signal outputter 365 that receives an output signal of the second comparator 363 and outputs the developing high voltage in the form of a DC, and a second OCP circuit 367 that stops the output of the developing circuit 360 when the developing circuit 360 outputs an over-current.

According to an example of the disclosure, the developing circuit 360 may receive a second AC voltage based on PWM control from the processor 220. The second AC voltage may be phase-shifted through the inverter, and may be converted into a second DC voltage through the LPF 321 and transmitted to the second comparator 363. At this time, the developing high-voltage signal output from the developing circuit 360 may be fed back to the second comparator 363. The second comparator 363 may compare the second DC voltage and a feedback voltage with a second reference voltage to output the second base voltage for generation of the developing high voltage. The second signal outputter 365 may receive the second base voltage to generate the developing high voltage and output the generated developing high voltage to the developing device 380.

The protecting circuit 340 may include a first protecting circuit 341 that stops the output of the developing circuit 360 when an error occurs in the charging circuit 320 and a second protecting circuit 351 that generates a signal for stopping the output of the charging circuit 320 when an error occurs in the developing circuit 360.

According to an example of the disclosure, the first protecting circuit 341 may be connected between the sensing circuit 327 and an input terminal of the second comparator 363. When the charging circuit 320 outputs an over-current, the first protecting circuit 341 may receive a sensing result indicating the over-current output of the charging circuit 320 from the sensing circuit 327 and block a developing input signal applied to the input terminal of the second comparator 363 by using at least one switch. More specifically, the first protecting circuit 341 may connect the input terminal of the second comparator 363 to a ground terminal by using at least one switch to block the developing input signal, thereby stopping the output of the developing circuit 360.

According to an example of the disclosure, the second protecting circuit 351 may be connected between the second signal outputter 365 and the first OCP circuit 329. When the developing circuit 360 outputs an over-current, the second protecting circuit 351 may output a stop signal to the first OCP circuit 329 by using a diode. More specifically, the second protecting circuit 351 may apply a voltage to the first OCP circuit 329 by using a diode to control the first OCP circuit 329 to stop the output of the charging circuit 320.

According to another example of the disclosure, the second protecting circuit 351 may be connected to the sensing circuit 327 When the developing circuit 360 outputs an over-current, the second protecting circuit 351 may transmit a signal indicating the over-current output of the developing circuit 360 to the first OCP circuit 329 through the sensing circuit 327, thereby controlling the first OCP circuit 329 to stop the output of the charging circuit 320.

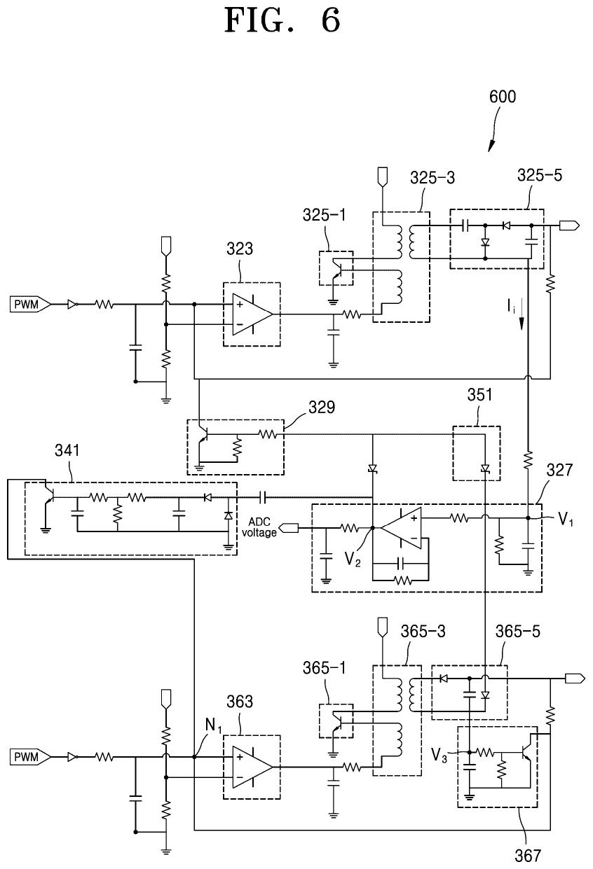

FIG. 6 is a circuit diagram 600 of the high-voltage power supply apparatus 250 according to various examples of the disclosure.

The high-voltage power supply apparatus 250 may output a charging high voltage to a charging device. The charging circuit 320 may receive a first AC voltage based on PWM control from the processor 220. The first AC voltage may be phase-shifted through an inverter, and may be converted into a first DC voltage through an LPF and transmitted to the first comparator 323. According to an example of the disclosure, the first comparator 323 may receive the first DC voltage passing through the LPF and a feedback voltage regarding the output of the charging circuit 320 through a + input terminal and a reference voltage through a − input terminal.

The first comparator 323 may output a base voltage for generation of the charging high voltage based on a difference between voltages of the + input terminal and the − input terminal. The first signal outputter 325 may receive the base voltage to generate the charging high voltage and output the generated charging high voltage to the charging device 370. More specifically, the base voltage may be converted into the charging high voltage by passing through a switching controller 325-1 that induces change of a voltage and a current of a transformer 325-3 through resonance, a transformer 325-3 that amplifies an output AC voltage passing through the switching controller 325-1, and a rectifier and multiplier 325-5 that converts an AC voltage into a DC voltage. The charging circuit 320 may output the generated charging high voltage to the charging device 370.

When an error occurs in the charging circuit 320, the rectifier and multiplier 325-5 may output an over-current. The sensing circuit 327 may sense the over-current output of the charging circuit 320 and transmit a sensing result to the first OCP circuit 329, the processor 220, and the first protecting circuit 341. In response, the first OCP circuit 329 may be connected between the sensing circuit 327 and the input terminal of the first comparator 323 to stop the output of the charging circuit 320. The first protecting circuit 341 may be connected between the sensing circuit 327 and the input terminal of the second comparator 363 of the developing circuit 360 to operate at least one switch, thereby stopping the output of the developing circuit 360.

According to an example of the disclosure, as the error occurs in the charging circuit 320, the rectifier and multiplier 325-5 may output an over-current I₁ to the sensing circuit 327. When the over-current is sensed in the sensing circuit 327, a magnitude of a voltage V₁ at the input terminal of the sensing circuit 327 may increase and a magnitude of a voltage V₂ at the output terminal of the sensing circuit 327 may also increase correspondingly. Thus, a voltage applied to the first OCP circuit 329 and the first protecting circuit 341 may increase.

As the voltage applied to the first OCP circuit 329 increases, a transistor switch of the first OCP circuit 329 may operate. As the transistor switch operates, the input terminal of the first comparator 323 may be connected to the ground terminal and the charging input signal applied through the first comparator 323 may be blocked. Thus, the first OCP circuit 329 may stop the output of the charging circuit 320. As the voltage applied to the first protecting circuit 341 increases, a transistor switch of the first protecting circuit 341 may operate. As a result, an input terminal Ni of the second comparator 363 may be connected to the ground terminal, and the developing input signal applied through the input terminal N₁ of the second comparator 363 may be blocked. Hence, the first protecting circuit 341 may stop the output of the developing circuit 360.

In the same manner, the high-voltage power supply apparatus 250 may output the developing high voltage to the developing device 380. The developing circuit 360 may receive the second AC voltage based on PWM control from the processor 220. The second AC voltage may be phase-shifted through an inverter, and may be converted into a second DC voltage through an LPF and transmitted to the second comparator 363. According to an example of the disclosure, the second comparator 363 may receive the second DC voltage passing through the LPF and a feedback voltage regarding the output of the developing circuit 360 through a + input terminal and a reference voltage through a − input terminal.

The second comparator 363 may output a base voltage for generation of the developing high voltage based on a difference between voltages of the + input terminal and the − input terminal. The second signal outputter 365 may receive the base voltage and generate the developing high voltage. Like the charging circuit 320, the base voltage may be converted into the developing high voltage by passing through a switching controller 365-1, a transformer 365-3, and a rectifier and multiplier 365-5, and the developing circuit 360 may output the generated developing high voltage to the developing device 380.

When an error occurs in the developing circuit 360, the rectifier and multiplier 365-5 may output an over-current. The second OCP circuit 367 may be connected between the rectifier and multiplier 365-5 and the second protecting circuit 351 to stop the output of the developing circuit 360. The second protecting circuit 351 may be connected between the second OCP circuit 367 and the first OCP circuit 329 to indirectly stop the output of the charging circuit 320.

According to an example of the disclosure, as an error occurs in the developing circuit 360, a magnitude of a voltage V₃ at the input terminal of the second OCP circuit 367 may increase. As a voltage applied to the second OCP circuit 367 increases, the input terminal N₁ of the second comparator 363 may be connected to the ground terminal and the developing input signal applied through the input terminal N₁ of the second comparator 363 may be blocked. As a result, the second OCP circuit 367 may stop the output of the developing circuit 360. As the magnitude of the voltage Vs at the input terminal of the second OCP circuit 367 increases, a high voltage may be applied to a diode of the second protecting circuit 351. Upon application of a voltage greater than or equal to a threshold voltage to the diode, the output current of the rectifier and multiplier 365-5 may pass through the first OOP circuit 329 to operate a transistor of the first OCP circuit 329. As a result, the input terminal of the first comparator 323 may be connected to the ground terminal, and the charging input signal applied through the input terminal of the first comparator 323 may be blocked.

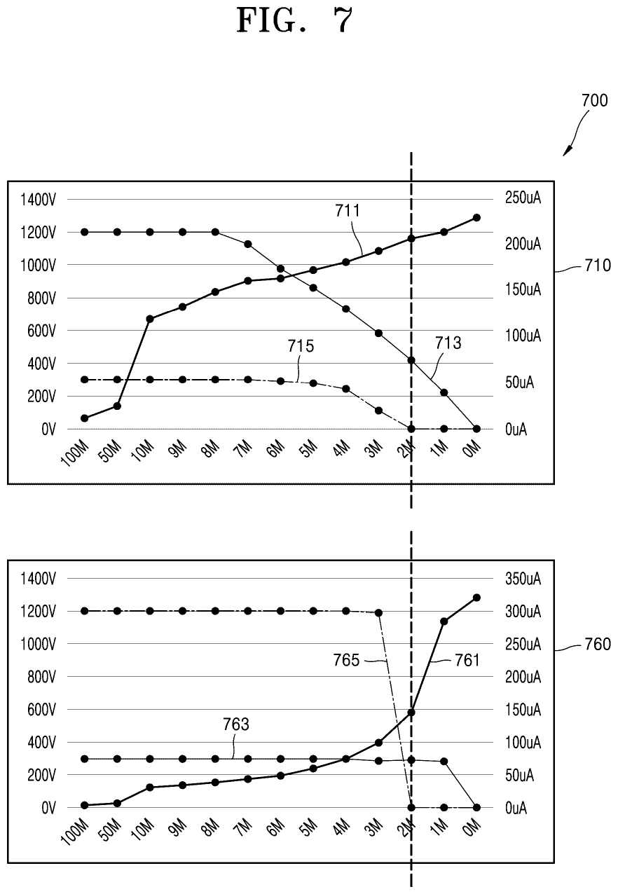

FIG. 7 is a graph 700 of an operation result of the high-voltage power supply apparatus 250 according to various examples of the disclosure.

FIG. 7 shows a result corresponding to a method where both the output of the charging circuit 320 and the output of the developing circuit 360 are stopped when an error occurs in at least one of the charging circuit 320 and the developing circuit 360.

A first graph 710 shows changes of a charging high voltage and a developing high voltage when a load connected to the charging circuit 320 decreases. In the first graph 710, a horizontal axis may indicate a load connected to the charging circuit 320 and a vertical axis may indicate a current value of an output current of the charging circuit 320 and voltage values of the charging high voltage and the developing high voltage. The first graph 710 shows a case where a current value of an over-current that is a criterion for determining whether an error occurs in the charging circuit 320 is 200 μA, but the current value of the over-current may change with user's setting.

Referring to the first graph 710, when a load of the charging device 370 connected to the charging circuit 320 is about 100 MΩ, an output current 711 may be about 11 μA, a charging high voltage 713 may be about 1199V, and a developing high voltage 715 may be about 300V. Herein, as the load of the charging device 370 decreases, the output current 711 may gradually increase, such that the output of the charging current may be 200 μA for the load of the charging device 370 being about 2 MΩ. In this case, the charging high voltage 713 may decrease in response to the operation of the first OCP circuit 329, and the developing high voltage 715 may decrease in response to the operation of the first protecting circuit 341. That is, when an error occurs in the charging circuit 320, the high-voltage output of the charging circuit 320 and the high-voltage output of the developing circuit 360 are stopped, thus protecting the image forming apparatus 100.

A second graph 760 shows changes of a charging high voltage and a developing high voltage when a load connected to the developing circuit 360 decreases. In the second graph 760, a horizontal axis may indicate a load connected to the developing circuit 360 and a vertical axis may indicate a current value of an output current of the developing circuit 360 and voltage values of the charging high voltage and the developing high voltage. The second graph 760 shows a case where a current value of an over-current that is a criterion for determining whether an error occurs in the developing circuit 360 is 140 μA, but the current value of the over-current may change with user's setting.

Referring to the second graph 760, when a load of the developing device 380 is about 100 MΩ, an output current 761 may be about 2.91 μA, a developing high voltage 763 may be about 291 V, and a charging high voltage 765 may be about 1200 V. Herein, as the load of the developing device 380 decreases, the output current 761 may gradually increase, such that the output of the developing current may be 140 μA for the load of the developing device 380 being about 2 MΩ. In this case, the developing high voltage 763 may decrease in response to the operation of the second OCP circuit 367, and the charging high voltage 765 may decrease as the first OCP circuit 329 operates in response to the stop signal from the second protecting circuit 351. That is, when an error occurs in the developing circuit 360, the high-voltage output of the charging circuit 320 and the high-voltage output of the developing circuit 360 are stopped, thus protecting the image forming apparatus 100.

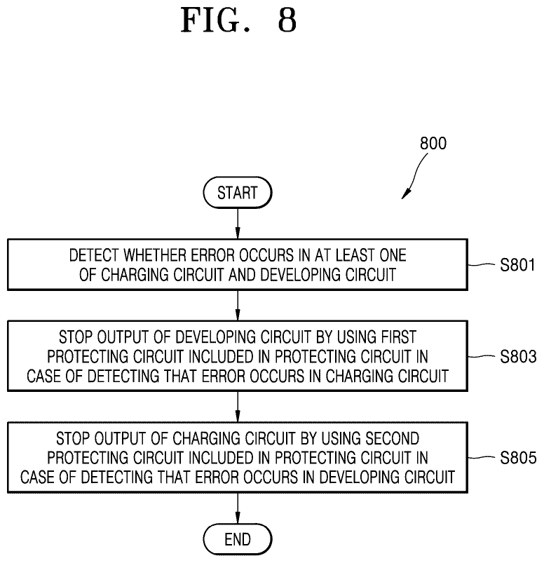

FIG. 8 is a flowchart 800 of an operating method of the high-voltage power supply apparatus 250 according to various examples of the disclosure. FIG. 8 shows an operating method of the high-voltage power supply apparatus 250 that supplies a high voltage to the charging device 370 and the developing device 380 by using the charging circuit 320, the developing circuit 360, and the protecting circuit 340.

Referring to FIG. 8, in operation 801, the high-voltage power supply apparatus 250 may detect whether an error occurs in at least one of a charging circuit and a developing circuit. The high-voltage power supply apparatus 250 may detect whether the charging circuit 320 outputs an over-current by using the sensing circuit 327. The high-voltage power supply apparatus 250 may detect whether the developing circuit 360 outputs an over-current by using the second OCP circuit 367.

In operation 803, the high-voltage power supply apparatus 250 may stop the output of the developing circuit by using the first protecting circuit included in the protecting circuit when the high-voltage power supply apparatus 250 detects that the error occurs in the charging circuit. When the charging circuit 320 outputs the over-current, the high-voltage power supply apparatus 250 may control the output of the developing circuit 360 to be stopped by using the first protecting circuit 341 connected between the sensing circuit and the input terminal of the second comparator.

According to an example of the disclosure, the high-voltage power supply apparatus 250 may detect whether the charging circuit outputs the over-current, stop the output of the charging circuit by using the first OCP circuit included in the charging circuit, and stop the output of the developing circuit by using the first protecting circuit.

In operation 805, the high-voltage power supply apparatus 250 may generate a stop signal for stopping the output of the charging circuit by using the second protecting circuit included in the protecting circuit when the high-voltage power supply apparatus 250 detects that the error occurs in the developing circuit. When the developing circuit 360 outputs the over-current, the high-voltage power supply apparatus 250 may control the output of the charging circuit 320 to be stopped by using the second protecting circuit 351 connected between the second signal outputter 365 and the second OCP circuit 367.

According to an example of the disclosure, the high-voltage power supply apparatus 250 may detect whether the developing circuit outputs the over-current, stop the output of the developing circuit by using the second OCP circuit included in the developing circuit, and stop the output of the charging circuit by using the second protecting circuit.

FIG. 1 is a diagram for describing an operation of an electronic device that provides a user interface related to an image forming apparatus, according to an example.

FIG. 3 is a diagram showing a configuration of an image forming apparatus according to an example.

The methods according to examples described in the claims or specification of the disclosure may be implemented by hardware, software, or a combination thereof.

When the methods are implemented by software, a computer-readable storage medium having stored therein one or more programs (software modules) may be provided. The one or more programs stored in the computer-readable storage medium may be configured for execution by one or more processors in an electronic device. The one or more programs include instructions that cause the electronic device to execute the methods according to the examples described in the claims or the specification of the disclosure.

These programs (software modules and software) may be stored in random access memories (RAMs), non-volatile memories including flash memories, read only memories (ROMs), electrically erasable programmable ROMs (EEPROMs), magnetic disc storage devices, compact disc-ROMs (CD-ROMs), digital versatile discs (DVDs), other types of optical storage devices, or magnetic cassettes. The programs may be stored in a memory configured by a combination of some or all of such storage devices. Also, each of the memories may be provided in plurality.

The programs may be stored to an attachable storage device of the electronic device accessible via the communication network such as Internet, Intranet, a local area network (LAN), a wide area network (WAN), or storage area network (SAN), or a communication network by combining the networks. The storage device may access a device performing an example of the disclosure through an external port. In addition, a separate storage device on a communication network may access a device performing an example of the disclosure.

In the above-described detailed examples of the disclosure, components included in the disclosure have been expressed as singular or plural according to the provided detailed examples of the disclosure. However, singular or plural expressions have been selected properly for a condition provided for convenience of a description, and the disclosure is not limited to singular or plural components and components expressed as plural may be configured as a single component or a component expressed as singular may also be configured as plural components.

It should be understood that examples described herein should be considered in a descriptive sense only and not for purposes of limitation. Descriptions of features or aspects within each example should typically be considered as available for other similar features or aspects in other examples. While one or more examples have been described with reference to the figures, it will be understood by those of ordinary skill in the art that various changes in form and details may be made therein without departing from the spirit and scope as defined by the following claims.

What is claimed is:

1. A high-voltage power supply apparatus to supply power in an image forming apparatus, the high-voltage power supply apparatus comprising:
a charging circuit to output a charging high voltage to a charging device of the image forming apparatus;
a developing circuit to output a developing high voltage to a developing device of the image forming apparatus; and
a protecting circuit to control output of the developing circuit to be stopped when an error occurs in the charging circuit, and to control output of the charging circuit to be stopped when an error occurs in the developing circuit.

2. The high-voltage power supply apparatus of claim 1, wherein the protecting circuit comprises:
a first protecting circuit to determine whether the charging circuit outputs an over-current and to stop the output of the developing circuit when the charging circuit outputs the over-current; and
a second protecting circuit to determine whether the developing circuit outputs an over-current and to generate a stop signal to stop the output of the charging circuit when the developing circuit outputs the over-current.

3. The high-voltage power supply apparatus of claim 2, wherein the charging circuit comprises:
a first comparator to control output of a first base voltage that is a basis to generate the charging high voltage;
a first signal outputter to receive an output signal of the first comparator and output a charging high voltage including a direct current (DC);
a sensing circuit to sense whether the charging circuit outputs an over-current from an output current of the first signal outputter; and
a first over-current protection (OCP) circuit to stop output of the charging circuit based on a sensing result of the sensing circuit.

4. The high-voltage power supply apparatus of claim 3, wherein the developing circuit comprises:
a second comparator to receive a developing input signal and control output of a second base voltage that is a basis to generate the developing high voltage;
a second signal outputter to receive an output signal of the second comparator and output a developing high voltage including a DC; and
a second OCP circuit to stop output of the developing circuit when the developing circuit outputs an over-current from an output current of the second signal outputter 5. The high-voltage power supply apparatus of claim 4, wherein the first protecting circuit is coupled between the sensing circuit and an input terminal of the second comparator.

6. The high-voltage power supply apparatus of claim 4, wherein when the charging circuit outputs an over-current, the first protecting circuit receives a sensing result indicating over-current output of the charging circuit from the sensing circuit, and blocks a developing input signal applied to the input terminal of the second comparator, by using at least one switch.

7. The high-voltage power supply apparatus of claim 6, wherein the first protecting circuit to connect the input terminal of the second comparator to a ground terminal using the at least one switch to block the developing input signal applied to the second comparator.

8. The high-voltage power supply apparatus of claim 4, wherein the second protecting circuit is coupled between the second signal outputter and the second OCP circuit.

9. The high-voltage power supply apparatus of claim 8, wherein when the developing circuit outputs an over-current, the second protecting circuit outputs the stop signal to the first OCP circuit by using a diode.

10. The high-voltage power supply apparatus of claim 8, wherein the second protecting circuit is coupled between the second signal outputter and the sensing circuit to output a signal indicating over-current output of the developing circuit to the sensing circuit.

11. An operating method of a high-voltage power supply apparatus to supply a high voltage to a charging device and a developing device by using a charging circuit, a developing circuit, and a protecting circuit, the operating method comprising:
detecting whether an error occurs in at least one of the charging circuit and the developing circuit;
stopping output of the developing circuit using a first protecting circuit included in the protecting circuit in a case of detecting that the error occurs in the charging circuit; and
generating a stop signal to stop output of the charging circuit using a second protecting circuit included in the protecting circuit in a case of detecting that the error occurs in the developing circuit.

12. The operating method of claim 11, wherein the stopping the output of the developing circuit comprises:
detecting whether the charging circuit outputs an over-current;
stopping the output of the charging circuit using a first over-current protection (OCP) circuit included in the charging circuit; and
stopping the output of the developing circuit using the first protecting circuit.

13. The operating method of claim 11, wherein the generating the stop signal to stop the output of the charging circuit comprises:
detecting whether the developing circuit outputs an over-current;
stopping the output of the developing circuit using a second OCP circuit included in the developing circuit; and
generating a stop signal for stopping the output of the charging circuit using the second protecting circuit.

14. The operating method of claim 11, further comprising:
by a first comparator included in the protecting circuit, controlling output of a first base voltage that is a basis to generate the charging high voltage;
by a first signal outputter included in the protecting circuit, receiving an output signal of the first comparator and outputting a charging high voltage including a direct current (DC);
by a sensing circuit included in the protecting circuit, sensing whether the charging circuit outputs an over-current from an output current of the first signal outputter; and
by a first over-current protection (OCP) circuit included in the protecting circuit, stopping output of the charging circuit based on a sensing result of the sensing circuit.

15. The operating method of claim 14, further comprising:
by a second comparator included in the developing circuit, receiving a developing input signal and controlling output of a second base voltage that is a basis to generate the developing high voltage;
by a second signal outputter included in the developing circuit, receiving an output signal of the second comparator and outputting a developing high voltage including a DC; and
by a second OCP circuit included in the developing circuit, stopping output of the developing circuit when the developing circuit outputs an over-current from an output current of the second signal outputter.
